(19) United States
(12) Patent Application Publication
(10) Pub. No.: US 2022/0138973 A1
(43) Pub. Date: May 5, 2022

(54) CROSS SECTION IMAGING WITH IMPROVED 3D VOLUME IMAGE RECONSTRUCTION ACCURACY

(71) Applicant: Carl Zeiss SMT GmbH, Oberkochen (DE)

(72) Inventors: Thomas Korb, Schwaebisch Gmuend (DE); Jens Timo Neumann, Aalen (DE); Eugen Foca, Ellwangen (DE); Alex Buxbaum, San Ramon, CA (US); Amir Avishai, Pleasanton, CA (US); Keumsil Lee, Palo Alto, CA (US); Ingo Schulmeyer, Moegglingen (DE); Dmitry Klochkov, Schwaebisch Gmuend (DE)

(21) Appl. No.: 17/540,976

(22) Filed: Dec. 2, 2021

Related U.S. Application Data
(63) Continuation of application No. PCT/EP2020/000101, filed on May 25, 2020.
(60) Provisional application No. 62/858,470, filed on Jun. 7, 2019.

(30) Foreign Application Priority Data
Sep. 20, 2019 (DE) 102019006645.6

(51) Int. Cl. G06T 7/33; G06T 7/35; G06T 5/00; G06T 7/55; G06T 7/73

(52) U.S. Cl. CPC G06T 7/33; G06T 7/35; G06T 5/006; G06T 7/55; G06T 2207/10016; G06T 2207/30148; G06T 2207/30204; G06T 2207/10056; G06T 7/73

(57) ABSTRACT

A three-dimensional circuit pattern inspection technique includes cross sectioning integrated circuits for obtaining a 3D volume image of an integrated semiconductor sample. The method employs a feature based alignment of cross section images based on features of an integrated semiconductor sample. A computer program product and apparatus are provided.

### CROSS-REFERENCE TO RELATED APPLICATIONS

The present application is a continuation of, and claims benefit under 35 USC 120 to, international application PCT/EP2020/000101, filed May 25, 2020, which claims benefit under 35 USC 119 of German Application No. 10 2019 006 645.6, filed Sep. 20, 2019, and U.S. Provisional Application No. 62/858,470, filed Jun. 7, 2019. The entire disclosure of each of these applications are incorporated by reference herein.

### FIELD

The present disclosure relates to a three-dimensional circuit pattern inspection and measurement technique by cross sectioning of integrated circuits. More particularly, the present disclosure relates to a method of obtaining a 3D volume image of an integrated semiconductor sample and to a corresponding computer program product and a corresponding semiconductor inspection device. The method, computer program product and device can be utilized for quantitative metrology, defect detection, defect review, and inspection of an edge shape of the pattern and to derive a line edge roughness or surface roughness of a fine pattern by using a scanning charged particle microscope.

### BACKGROUND

Semiconductor structures are amongst the finest man-made structures and suffer from very few imperfections only. These rare imperfections are the signatures which defect detection or defect review or quantitative metrology devices are looking for. Fabricated semiconductor structures are based on prior knowledge. For example, in a logic type sample, metal lines are running parallel in metal layers or HAR (high aspect ratio) structures and metal vias run perpendicular to the metal layers. The angle between metal lines in different layers is either 0° or 90°. On the other hand, for VNAND type structures it is known that their cross sections are spherical on average.

In the fabrication of integrated circuits, the features size is becoming smaller. The current minimum feature size or critical dimension is below 10 nm, for example 7 nm or 5 nm, and approaching below 3 nm in near future. Therefore, measuring edge shapes of patterns, and to determine the dimensions of features or the line edge roughness with high precision can become challenging. Edge shapes of patterns or roughness of lines can be subject to several influences. Generally, the edge shape of a line or pattern may be subject to the property of involved materials itself, the lithography exposure or any other involved process step, such as etching, deposition, or implantation. The measurement resolution of charged particle systems is typically limited by the sampling raster of individual image points or dwell times per pixel on the sample, and the charged particle beam diameter. The sampling raster resolution can be set for the imaging system, but should be adapted to the charged particle beam diameter on the sample. The typical raster resolution is 2 nm or below, but the raster resolution limit can be reduced with no physical limitation. The charged particle beam diameter has a limited dimension, which can depend on the charged particle beam operation conditions and lens. The beam resolution is generally limited by approximately half of the beam diameter. The resolution can be below 2 nm. However, well known deconvolution techniques can be applied to improve, for example, edge detection. Despite the high measurement resolution of actual charged particle systems of few, for example below 2 nm, it is challenging to obtain a measurement accuracy in 3D volumes with accuracy better than 10 nm. As an example, reference is made to Dunn, Kubis and Hull “Quantitative Three-Dimensional Analysis using Focused Ion Beam Microscopy” in “Introduction to Focused Ion Beams” edited by Gianuzzi and Stevie (2005). Here, the demonstrated 3D resolution is about 30 nm.

A common way to generate 3D tomographic data from semiconductor samples on nm scale is the so-called slice and image approach elaborated for example by a dual beam device. In such an apparatus, two particle optical systems are arranged at an angle. The first particle optical system can be a scanning electron microscope (SEM). The second particle optical system can be a focused ion beam optical system (FIB), using for example gallium (Ga) ions. A focused ion beam (FIB) of Ga ions is used to cut off layers at an edge of a semiconductor sample slice by slice and every cross section is imaged using a scanning electron microscope (SEM). The two particle optical systems might be oriented perpendicular or at an angle between 45° and 90°. FIG. 1 shows a schematic view of the slice and image approach: using a FIB optical column 50, with a focused ion particle beam 51 in y-direction, and scanning in x-y-plane, a thin layer from the cross section through a semiconductor sample 10 is removed to reveal a new front surface 52 as a cross section image plane 11. In a next step, a SEM (not shown) is used for scanning imaging the front surface of the cross section 11. In this example, the SEM optical axis is oriented parallel to the z-direction, and the scanning imaging lines 82 in x-y-plane raster scan the cross section image plane 11 and forms cross section images or slices 100. By repetition of this approach through for example front surfaces 53 and 54, a sequence of 2D cross section images 1000 through the sample in different depths is obtained. The distance dz between two subsequent image slices can be 1 nm-10 nm. From the sequence of these 2D cross section images 1000, a 3D image of the integrated semiconductor structure can be reconstructed.

With the finer detail and the smaller feature sizes in modern integrated circuits, the reconstruction of the 3D tomographic image implies several challenges. Lateral stage drifts or drifts of the SEM column may cause offsets in the lateral positions of the structures from slice to slice. Variations in the FIB cutting rate may cause the intersection surfaces to be at varying distances. Image distortions may lead to cross section images with for example pin-cushion or shear distortion. FIG. 2 shows an example of a reconstruction of x-z-slices from a sequence of x-y cross section images. For sake of simplicity, only three cross section images 100.1, 100.2, 100.3 at z-positions z1, z2 and z3 are shown of the sequence of 2D cross section images 1000. The random stage or SEM drifts can lead to artificially enhanced line edge roughness of the metal lines 101 which are extended in z direction or large variations of the width of the metal lines 102 which are extended in parallel to the z-direction.

It is a common method to derive the lateral position of each slice as well as the distance from layer to layer with the help of so called fiducials. U.S. Pat. No. 9,633,819 B2 discloses an alignment method based on guiding structures (“fiducials”) exposed to the top of the sample. FIGS. 3A, 3B and 3C illustrate the alignment with fiducials. As will be explained below in more detail, marker structures 21 and 22 are formed into a deposition material 20 on top of the sample perpendicular to the direction of the cross sections before the FIB cutting of intersections 52, 53 and 54 begins. After slicing and imaging the cross sections, each cross section image contains also a cross section image segments 25 and 27 of the fiducials or alignment markers 21 and 22. The first central markers 21 are used to perform the lateral alignment amongst the slices while the distance between the two outer, second markers 22, leading to two cross section image segments 27, is used to calculate the distance between each slice.

U.S. Pat. No. 7,348,556 discloses a method to derive the line edge roughness based on a fiducial. Here, the fiducial is either already present on the surface of the workpiece or probe, or is milled at the location within a field of view.

However, the precision by using the fiducials can be limited by the fiducial generation process as well as the measurement precision of the charged particle optical column for measuring the fiducial position. The fiducial markers are typically coarse and may measure several 20 nm up to 100 nm and may also change arbitrarily their shape from the first to last slice such that the precision of the reconstruction is not sufficient for recent semiconductor structures of much smaller size and better overlay accuracy. FIGS. 4A and 4B, explained below in more detail, shows a result of a residual reconstruction induced line edge roughness without (FIG. 4A) and with alignment (FIG. 4B). Drifts of stage or charged particle beam column can become more severe with the reduced sizes of actual structures of interest.

This and other effects can lead to artificially inhomogeneous edge shapes and positions and can limit the precision metrology of interconnected circuit patterns. In a 3D-reconstruction, wavy metal lines can be created and for example a line edge roughness measurement can be deteriorated by alignment errors. The metrology of dimensions of a fine pattern, or the derivation of a line edge roughness or surface roughness with high accuracy of a fine 3D pattern by cross sectioning may not be possible. At least certain known approaches are not able to address issues related to the recent high precision measurement for integrated circuits with minimum features sizes down to critical dimensions (CD) of 7 nm and below.

### SUMMARY

The present disclosure seeks to provide an improved method of obtaining a 3D volume image of an integrated semiconductor sample by cross sectioning of the integrated semiconductor sample. Desirably, the method can allow for an increased 3D reconstruction accuracy.

The present disclosure can provide a method for high precision, 3D reconstruction of 3D volume images of three-dimensional circuit pattern inspection by cross sectioning of the integrated circuits and a method, computer program product and apparatus for obtaining 3D volume images of an integrated semiconductor sample free of measurement artefacts induced by stage drift, imaging column drift or image distortion.

The method can allow for quantitative metrology of line edge positions, line edge roughness, feature dimensions or areas, for defect detection or defect review with high accuracy. Furthermore, the disclosure can provide a method, computer program product and apparatus for inspecting an edge shape of the fine pattern and to derive a line edge roughness or surface roughness of a fine pattern with high accuracy.

A concept provided in the present disclosure is basing the reconstruction of the 3D volume image on characteristic data that is known and/or provided with higher accuracy than the accuracy with which fiducials can be provided. As already explained above, the accuracy of the fiducials themselves can be limited. Therefore, according to the present disclosure, the characteristic data used for alignment of cross section images for the reconstruction of the 3D volume image can be no positional data of fiducials, but the characteristic data can be based on more accurately known and/or provided inner structures or features of an integrated semiconductor sample. These inner structures or features are for example metal lines, interconnects, a via, HAR structures or a gate structure. The alignment applied in the method of obtaining a 3D volume image of an integrated semiconductor sample according to the disclosure can therefore be termed a feature based or structure based alignment which expressions are used as synonyms within the present patent application.

In more detail, the feature based alignment can apply an inventive precision alignment of a sequence of cross section images to reconstruct a 3D tomographic data set or 3D volume image. The precision alignment can include methods for applying an alignment correction scheme and adjusting the slice positions according to the alignment correction scheme. The alignment correction scheme can be based on image or feature registration. Image registration generally refers to precision placement of cross section images in 3D volumes. Image registration can utilize features of integrated circuits such as metal lines, which are present in at least a part of the cross section images. With these features, present in at least two of consecutive cross sections images, the relative lateral position and rotation of the two consecutive cross section images can be determined with high accuracy. With this feature-based alignment, a higher accuracy can be obtained by the positions of features of integrated circuits, which are fabricated with high precision of current integrated semiconductor fabrication techniques.

Additionally, the accuracy can be improved by statistical methods, such as centroid extraction of features of structures present in integrated semiconductor samples, such as gates, metal lines or HAR structures, for example HAR channels. Other statistical methods can include averaging of measurement positions of several image features, or may consider outliers which deviate too much relative to a statistical expectation value. Thereby, a subpixel accuracy of the image alignment of individual cross section images can be achieved. Thereby, image registration of 2D cross section images can be achieved in 3D volume images with high, sub-pixel accuracy.

According to the disclosure, influences of a lateral stage drift as well as errors of the scanning charged particle image acquisition method can be reduced.

Furthermore, imaging aberrations such as distortion errors of the scanning charged particle imaging method and apparatus can be extracted and removed by image processing, utilizing the features or structures of integrated semiconductor samples. Low-order distortion aberration changes between consecutive image slices can be extracted and removed from the cross section images.

The disclosure will now be described in more detail.

According to a first aspect of the disclosure, the disclosure is directed to a method of obtaining a 3D volume image of an integrated semiconductor sample by feature based alignment, characterized by: obtaining at least a first cross section image and a second cross section image parallel to the first cross section image, wherein obtaining the first and second cross section images includes subsequently removing a cross section surface layer of the integrated semiconductor sample using a focused ion beam to make a new cross section accessible for imaging, and imaging the new cross section of the integrated semiconductor sample with an imaging device; and obtaining a feature based alignment of the at least first and second cross section images by image registration of each of the at least first and second cross section images, wherein the image registration is performed based on at least one common feature of the integrated semiconductor sample in the at least first and second cross section images.

The common feature that is present in the at least first and second cross section images is provided within the integrated semiconductor sample with high positional precision. Therefore, using data of this at least one common feature as a reference for image registration can allow for a higher accuracy in alignment as well.

According to an embodiment of the disclosure, the at least one common feature includes at least one of a metal line, a via, a HAR structure, a HAR channel or a gate structure. All these features can be linear or linearly elongated. They are provided and/or their position(s) are known in integrated semiconductor samples with a relatively high accuracy which can be for example in the range of 4 nm to 2 nm or even below 1 nm precision for the lowest and finest layers in the samples.

The image registration can be performed based on two or more common features. It can for example be performed based on three, four, five, ten, twenty or even more common features. The more common features contribute to the image registration performed, the better the alignment accuracy can become: The imaging accuracy for imaging the new cross section of the integrated semiconductor sample with an imaging device can be limited, but statistical approaches can be used to statistically improve the imaging accuracy and therefore the image registration process.

According to an embodiment, the image registration includes a statistical evaluation. This statistical evaluation can operate on the data of the individual cross section images and/or on the data of the 3D volume image. Here, the more cross section images are obtained, the more powerful statistical evaluation becomes. The statistical evaluation can include at least one of a computation of a centroid, a feature detection or a statistical averaging. In these cases, the statistical evaluation can operate on the data of the individual cross section images.

According to an embodiment of the disclosure, the method includes providing a fiducial based alignment of the at least first and second cross section images by measuring and evaluation of the position of alignment marks previous to the feature based alignment. In this way, a stepwise alignment can be carried out. The fiducial based alignment has a lower accuracy than the feature based alignment of the present disclosure. However, in some situations, stepwise alignment is desired, for example when the cross section images include highly repetitive structures/features.

According to an embodiment of the present disclosure, imaging of the new cross section of the integrated semiconductor sample is performed with at least one of a charged particle device, an atomic force microscope or an optical microscope. Different imaging techniques can be combined, for example for getting an overview image with comparatively low resolution first before taking an image with higher or highest resolution. An example for a charged particle device operating with high resolution is a scanning electron microscope employing a single electron beam (SEM) or a plurality of electron beams (multi SEM).

According to an embodiment, imaging the new cross section of the integrated semiconductor sample is performed with a charged particle device operating with electrons, wherein the focused ion beam and the electron beam are arranged and operated at an angle to each other and a beam axis of the focused ion beam and a beam axis electron beam intersect each other. The angle between the focused ion beam and the electron beam can for example be 90°, however, other angles are also possible.

According to an embodiment of the present disclosure, the at least a first and second cross section images are formed perpendicular to a top surface of the integrated semiconductor sample. Here, the top surface of the integrated semiconductor sample is assumed to be flat or it can be approximated as a flat surface or a flat surface can be fitted to the real surface mathematically. The top surface can also include a protective layer and/or a cap in which fiducials can be provided.

The at least a first and second cross section images can be formed perpendicular to metal lines or gates of at least one metal layer of the integrated semiconductor sample. These features are provided in a respective layer of the integrated semiconductor sample. They consequently intersect with the cross section images and are normally visible in more than one cross section image and can thus be used for the feature based high precision alignment. According to the geometric arrangement of this embodiment, the position of these features does not/shall not vary in different cross section images. This geometric arrangement is therefore suited for a lateral alignment in the x-y plane.

According to an embodiment of the disclosure, the at least a first and second cross section images are formed inclined at an angle deviating from 90° to metal lines or gates of at least one metal layer of the integrated semiconductor sample. The angle can deviate from 90° in several, for example all, metal layers of the integrated semiconductor sample. When the angle deviates from 90°, the geometric arrangement can also be suited for a precision alignment in the z-direction, say for precisely determining the distance of the plurality of cross section images with respect to each other in z-direction. According to an embodiment, the angle is 45°, but it can be also 30° or 60° or another angle.

According to an embodiment of the present disclosure, the at least a first and second cross section images are formed inclined to a top surface of the integrated semiconductor sample to reveal cross section images of at least one HAR channel perpendicular to the top surface of the integrated semiconductor sample. These HAR channels are comparatively fine, often pillar like and elongated structures extending through significant parts of the integrated semiconductor sample. The finer and the more elongated a structure is, generally the more precise is an alignment based on this structure. According to this embodiment, the cross section images are normally also formed inclined to layers of the integrated semiconductor sample. The top surface and the layers can be provided parallel to each other. According to this embodiment, it is possible to determine the positions of the HAR channels, to determine the distance dz between subsequent cross section images and to carry out a lateral alignment in the x-y plane.

According to an embodiment of the present disclosure, the at least a first and second cross section images are formed inclined to a top surface of the integrated semiconductor sample and a distance between the at least first and second cross section images is determined based on a position of fiducials provided on the top surface. As already explained above, the accuracy of fiducial based alignment is in principle smaller than the accuracy of feature based alignment according to the present disclosure. However, if a fiducial based alignment is applied prior to a feature based alignment, the accuracy of the fiducial based alignment can be increased by a factor of sin (3, wherein the angle (3 determines the angle between the axis of the focused ion beam and the top surface of the integrated semiconductor circuit. The smaller and therefore more glancing the angle (3 is, generally the better the accuracy of fiducial based alignment becomes.

Similarly, according to an embodiment of the disclosure, the at least a first and second cross section images are formed inclined to a top surface of the integrated semiconductor sample and a distance between the at least first and second cross section images is determined based on a position of features, for example HAR channels, provided inside the integrated semiconductor sample and perpendicular to the top surface. Here, the accuracy of determining a distance between subsequent features, for example HAR channels, can be enhanced by the factor sin (3, wherein the angle (3 determines the angle between the axis of the focused ion beam and the top surface of the integrated semiconductor circuit.

According to an embodiment of the disclosure, the image alignment includes subtraction of an image distortion deviation between the at least first and second cross section images. The subtraction of the image distortion deviation can include an approximation of the image distortion deviation by a basis distortion function.

According to an embodiment of the present disclosure, the method further includes the following steps: determining a curtaining signature of the new cross section; and using the curtaining signature for representing the cross section images as 3D cross section images.

The material removal rate of a focused ion beam can depend on the type of material being removed. For this reason, the surface of a new cross section obtained with a constant feed, but including different materials, may not be ideally flat, but may show a certain topography. It is often wavy like a curtain (“curtaining effect”). The images of a respective wavy surface show lines as artefacts which can in principle be misinterpreted as a feature or structure. Therefore, it is possible to carry out a curtaining correction. In certain known approaches, a curtaining correction is carried out by the so-called rocking stage method applying certain movements of the stage to remove a surface layer with the focused ion beam from different directions, thereby averaging out the wavy structure. However, the rocking stage method may not be suited for tomographic appliances, since slices of to be removed are too thin and respective errors or the drift of the stage is too big. Therefore, according to the present disclosure, another approach is taken: The wavy topography of the surface is measured and appropriately taken into consideration in the further procedure. Curtaining, or more general topography effects, can deteriorate the quality of the 3D reconstruction in that, e.g. reconstructed metal line cross sections are not rectangular but sheared or show bulges. Topography means that not all points in the image belong to the same plane, but they have an individual out of plane (z-) coordinate. If this information is not available, in the reconstruction the voxels are placed incorrectly.

Determining the curtaining signature therefore includes determining the 3D topography of the new cross section. The term signature indicates that the wavy topography is like a fingerprint/characteristic of the new cross section that is imaged. However, the term curtaining signature is not limited to a 3D topography generated because of a curtaining effect. The term curtaining signature covers a 3D topography of a cross section image or slice in general.

Methods for determining the 3D topography of a surface are in principle known. An example is given by Tadao Sugunuma in “Measurement of Surface Topography Using SEM with Secondary Electron Detectors”, J. Electron. Microsc., Vol. 34, No. 4, 428-337, 1985. Shadowing effects of 3D structures during imaging can be overcome. A solution is to use at least two different detectors for detecting the same signal from different directions. In more detail, particles emanating from the surface that is scanned are detected under two different angles. The arrangement of the detectors can be symmetric with respect to a normal of the surface to be imaged. Using the differential signal of the at least two detector signals allows for determining the 3D topography with high precision. Thus, the 3D topography of the new cross section image is obtained and the curtaining signature is determined. In a next step of the method according to the present disclosure, the curtaining signature is used for representing the cross section images as 3D cross section images. These 3D cross section images are not exactly flat, but often slightly curved and the position of image data is characterized in three dimensions x, y, z. The image registration is then performed on the basis of the 3D or wavy cross section images. This can significantly enhance the accuracy of the claimed method. Furthermore the measured 3D topography can be used in the reconstruction of the 3D volume: If this information is available, instead of simply stacking up slices, the true (x,y,z) positions of every point are used, i.e. a mathematical correction of the topography effects in the reconstruction can be performed.

According to an embodiment, the method further includes the following steps: determining a curtaining signature of the new cross section; and using the determined curtaining signature in a feedback loop for controlling the focused ion beam while removing the next cross section surface layer of the integrated semiconductor sample.

As already explained above, a new delayered cross section surface is not exactly flat, but exhibits a 3D topography defining the curtaining signature. So when delayering the next cross section to exhibit the next new cross section, this 3D topography can be taken into consideration and the focused ion beam can be controlled respectively to get a new cross section that is as flat as possible. The ion beam can be controlled to act longer and/or more often at positions representing a maximum in topography and shorter and/or less often at positions representing a minimum in topography. Thus, the next new surface will be more flat per se. Practically, the described kind of control can be integrated into the inventive method in terms of a feedback loop.

According to an embodiment of the disclosure, the method further includes aligning the at least first and second cross section images based on a predetermined footprint shape of features and/or a spatial distribution of the features in the cross section images. This kind of alignment(s) is useful when there exists prior knowledge about features/structures within the sample that is investigated and these features/structures are of a specific known geometric shape and/or when these features/structures are regularly spatially arranged. Based on prior knowledge about the features/structures, the ideal geometric shape of these features/structures in cross section images is known and a reference or footprint of these features/structures can be defined. If the features are for example pillar like features, for example pillar like HAR channels, then their footprint in a cross section image perpendicular to the main axis of the pillar like features is ideally circular. If the cross section images are taken inclined to the main axis of the pillar like features, their footprint is elliptical. If the imaged footprints deviate from the previously known and ideally assumed shape, the reason can be a misalignment in the direction perpendicular to the cross section images that can be corrected. In other words, the distance between subsequent cross section images shows a variation. Varying the distance of the cross section images in the direction of the virtual image plane can eliminate the distortion error in this direction.

According to an embodiment, the footprint shape of the features is circular or elliptical. These well-defined geometric shapes can allow for a very precise determination of deviations from the ideal shape and/or position.

According to an embodiment, the aligning is carried out in a direction perpendicular to the image planes of the cross section images and/or the aligning is carried out within the image plane of the cross section images. This can allow for a high precision alignment.

According to an embodiment of the present disclosure, after the image registration the at least first and second cross section images are combined to a 3D volume image. This 3D volume image is a tomographic image.

According to an aspect of the disclosure, the disclosure is directed to a computer program product with a program code for executing the method according to any one of the embodiments described above. The code can be written in any possible programming language and can be executed on a computer control system. The computer control system as such can include one or more computers or processing systems.

According to an aspect of the disclosure, the disclosure is directed to a semiconductor inspection device adapted to perform any of the methods according to any one of the embodiments as described above.

According to an embodiment, the semiconductor inspection device includes: a focused ion beam device; and a charged particle operating device operating with electrons and adapted for imaging of the new cross section of the integrated semiconductor sample, wherein the focused ion beam and the electron beam are arranged and operated at an angle to each other and a beam axis of the focused ion beam and a beam axis electron beam intersect each other.

The beam axis of the focused ion beam and the top surface of the integrated semiconductor sample can form an angle of about 90° with one another, and the focused ion beam and the electron beam form an angle of about 90° with one another. This geometric arrangement is one of the standard geometric arrangements of the semiconductor inspection device, since the directions of the cross section images for image registration fit to the geometric shape of the integrated semiconductor sample and a 3D volume image can be easily determined.

According to an embodiment, the beam axis of the focused ion beam and the top surface of the integrated semiconductor sample form an angle of about 25° with one another, and the focused ion beam and the electron beam form an angle of about 90° with one another. With this arrangement, a glancing incidence by angle β of the focused ion beam onto the integrated semiconductor sample can be realized which allows for higher precision when determining the distance between subsequent cross section images by a factor sin β. Other angles, for example 30°, or 60° are also possible. Additionally, the space for arrangement of the charged particle operating device operating with electrons becomes bigger which facilitates the overall arrangement and design of a cross beam device. For example, a more flat objective lens can be applied resulting in a reduced working distance for the electron beam which can be for example 5 mm or less. A typical working distance of the FIB is then for example in the range of 12 mm.

According to an embodiment, an imaging device for imaging the new cross section of the integrated semiconductor sample includes at least two detection units arranged at different positions for detecting particles emanating from the new cross section at different angles. This arrangement can be applied for determining a curtaining signature/3D topography of a cross section as described above. The arrangement of the detection units can be symmetric with respect to angles formed with a normal of the surface of the cross section and/or the detection units are provided opposite to one another in a scanning direction of the focused ion beam. The imaging device can include exactly two or exactly four detection units. Two detectors forming a pair are sufficient to determine the topography of the surface in one direction. Therefore, with four detection units, it is possible to determine the topography of the surface in two orthogonal directions, for example the topography (height, depth) of the x-y-plane. Generally, the detection units can be of any suitable kind. However, it is optional that at least two detection units forming a pair are of the same kind. This can facilitate signal processing. The detection units can detect for example back scattered electrons or secondary electrons emanating from the surface of the new cross section.

According to an aspect of the disclosure, the disclosure is directed to a method of obtaining a 3D volume image of an integrated semiconductor sample, characterized by: obtaining a sequence of N cross section images, wherein obtaining the sequence of N cross section images includes subsequently removing a cross section surface layer of the integrated semiconductor sample using a focused ion beam to make a new cross section accessible for imaging, and imaging the new cross section of the integrated semiconductor sample with a charged particle imaging device, wherein each of a cross section image planes of the sequence of N cross section images is oriented perpendicular to a z-direction, and wherein the integrated semiconductor sample is arranged that the direction parallel to a set of L metal lines of at least one metal layer Mk of the integrated semiconductor sample forms an angle with a cross section images plane, and wherein at least a subset of the sequence of N cross section images includes cross section image segments of the L metal lines; extracting a position P(x,y;l) of each of the cross section image segments of the l=1 to L metal lines; forming traces T(x,y;z;l) of the positions P(x,y;l) through the z-direction of at least a subset of the sequence of N cross section images; decomposing the traces T(x,y;z;l) into an average common wavy structure TA(x,y;z) and a residual deviation dT(x,y;z;l); and correcting the position of at least the subset of the sequence of N cross section images within the 3D volume image by displacing the subset of the sequence of N cross section images with the common wavy structure TA(x,y;z).

According to an embodiment, the extraction of at least one position P(x,y;l) includes at least one of edge extraction, corner localization or feature localization of the cross section image of the metal line l.

According to an embodiment, the extraction of at least one position P(x,y;l) includes centroid or center of gravity computation.

According to an aspect of the disclosure, the disclosure is directed to a computer program product with a program code for executing the method according to the fourth aspect of the disclosure.

According to an aspect of the disclosure, the disclosure is directed to a semiconductor inspection device adapted to perform any of the methods according to the fourth aspect of the disclosure.

The embodiments as described above can be fully or partly combined with one another, as long as no technical contradictions occur. This also holds for embodiments describing different aspects of the disclosure.

### BRIEF DESCRIPTION OF THE DRAWINGS

The present disclosure will be even more fully understood with reference to the following drawings, in which:

FIG. 1 is an illustration of the cross section imaging technique;

FIG. 2 is an illustration of cross section images and two examples of intersection images through the 3D volume image;

FIGS. 3A-3C are an illustration of the fiducial alignment process as described in prior art;

FIGS. 4A and 4B are an illustration of the result of fiducial based alignment at the example of an intersection image at the example of a metal layer M1;

FIGS. 5A-5D are an illustration of the cross section image technique utilizing the feature based alignment;

FIG. 6 is an illustration of traces of image features through a stack of cross section images including 400 cross section images;

FIG. 7 is an illustration of the improvement achieved by an embodiment of the feature-based alignment, at the example of a metal layer M1;

FIGS. 8A and 8B are an illustration of the improvement achieved by an embodiment of the disclosure at the example of a gate layer;

FIGS. 9A and 9B are an illustration of the improved line edge roughness derivation by an embodiment of the disclosure;

FIG. 10 is an illustration of a slice-to-slice distortion deviation;

FIGS. 11A and 11B are an illustration of an embodiment of the feature based alignment for cross section imaging with cross sections inclined to the metal lines in at least on metal layer;

FIGS. 12A and 12B are an illustration of an embodiment of the feature based alignment for cross section imaging with cross sections inclined to an orientation of HAR channels in a sample, e.g. a memory device, to reveal cross section images of HAR channels;

FIGS. 13A and 13B are an illustration comparing accuracy of a distance determination between subsequent cross section images perpendicular to the top surface of an integrated semiconductor sample and subsequent cross section images inclined to the foresaid orientation;

FIG. 14 is an illustration of the curtaining effect imaging a VNAND structure;

FIG. 15 schematically illustrates an arrangement for determining the 3D topography of a surface;

FIG. 16 is an illustration of a 3D cross section image;

FIG. 17 is an illustration of pillar like HAR channels on a regular hexagonal grid in a VNAND memory probe;

FIG. 18 is an illustration of a footprint shape based alignment; and

FIG. 19 schematically further illustrates details of the footprint shape based alignment of FIG. 18.

### DETAILED DESCRIPTION

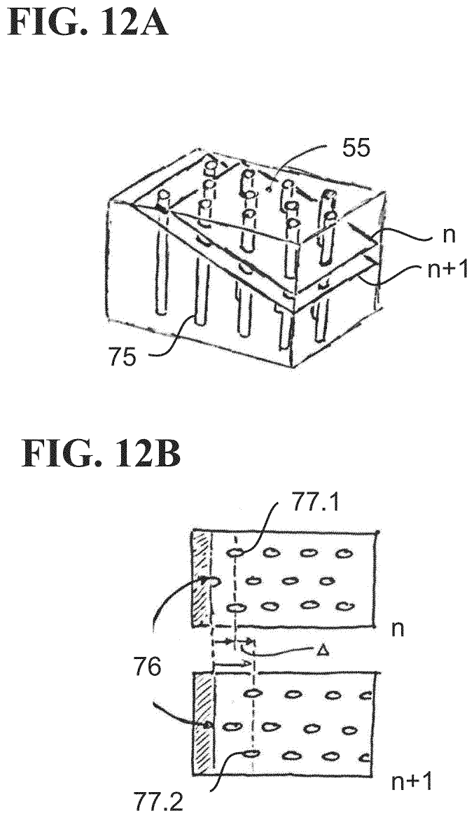

FIGS. 12A and 12B show a schematic view of the cross section image approach to obtain a 3D volume image of an integrated semiconductor sample. With the cross section approach, three dimensional (3D) volume image acquisition is achieved by a “step and repeat” fashion. First, the integrated semiconductor sample is prepared for the subsequent cross section image approach by methods known in the art. Throughout the disclosure, “cross section image” and “slice” will be used as synonyms. Either a groove is milled in the top surface of an integrated semiconductor to make accessible a cross section approximately perpendicular to the top surface, or an integrated semiconductor sample 10 of block shape is cut out and removed from the integrated semiconductor wafer. This process step is sometimes referred to as “lift-out”. In a step, a thin surface layer or “slice” of material is removed. For sake of simplicity, the description is shown at such a block shaped integrated semiconductor sample 10, but the disclosure is not limited to block shaped samples 10. This slice of material may be removed in several ways known in the art, including the use of a focused ion beam milling or polishing at glancing angle, but occasionally closer to normal incidence by focused ion beam (FIB) 50. For example, the focused ion beam 51 is scanned along direction x to form a cross section 52. As a result, a new cross section surface 11 is accessible for imaging. In a subsequent step, the newly accessible cross section surface layer 11 is raster scanned by a charged particle beam (CPB), such as a scanning electron microscope (SEM) or a FIB (not shown). The imaging system optical axis can be arranged to be parallel to the z-direction, or inclined at an angle to the z-direction. CPB systems have been used for imaging small regions of a samples at high resolution of below 2 nm. Secondary as well as backscattered electrons are collected by a detector (not shown) to reveal a material contrast inside of the integrated semiconductor sample, and visible in the cross section image 100 as different grey levels. Metal structures generate brighter measurement results. The surface layer removal and the cross section image process are repeated through surface 53 and 54 and further surfaces at equal distance, and a sequence of 2D cross section images 1000 through the sample in different depths is obtained so as to build up a three dimensional 3D dataset. The representative cross section image 100 is obtained by measurements of a commercial Intel processor integrated semiconductor chip with 14 nm technology.

With the method, at least a first and second cross section images includes subsequently removing a cross section surface layer of the integrated semiconductor sample with a focused ion beam to make a new cross section accessible for imaging, and imaging the new cross section of the integrated semiconductor sample with a charged particle beam. From the sequence of these 2D cross section images 1000, a 3D image of the integrated semiconductor structure can be reconstructed. The distance dz of the cross section images 100 can be controlled by the FIB milling or polishing process and can be between 1 nm and 10 nm, such as about 3-5 nm.

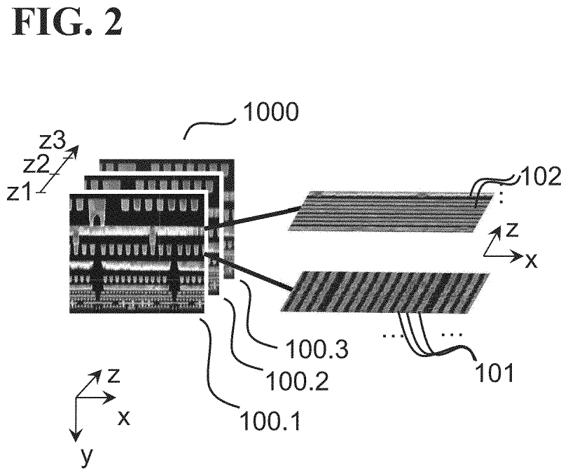

FIG. 2 shows an example of two x-z-intersection images from the reconstructed 3D volume image or 3D data set obtained from a sequence of N=400 image slices or cross section images 1000 obtained in x-y-direction, and spaced in z-direction by distance dz. For sake of simplicity, only three cross section images 100.1, 100.2, 100.3 are illustrated. The random stage or SEM drifts between acquisition of the N=400 image slices lead to artificially enhanced line edge roughness in z-direction, visible in the metal lines 101 extended in z-direction, or large variations of the widths of metal lines 102, oriented perpendicular to the z-direction.

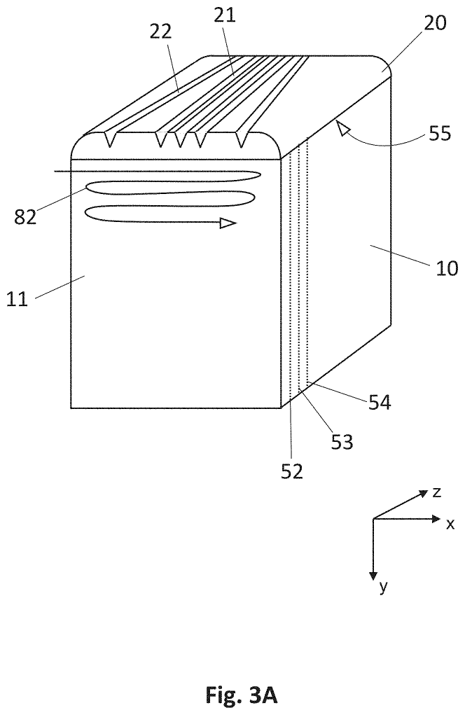

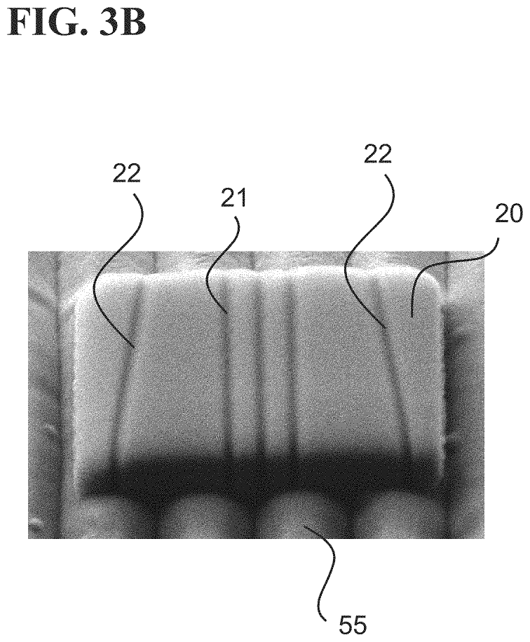

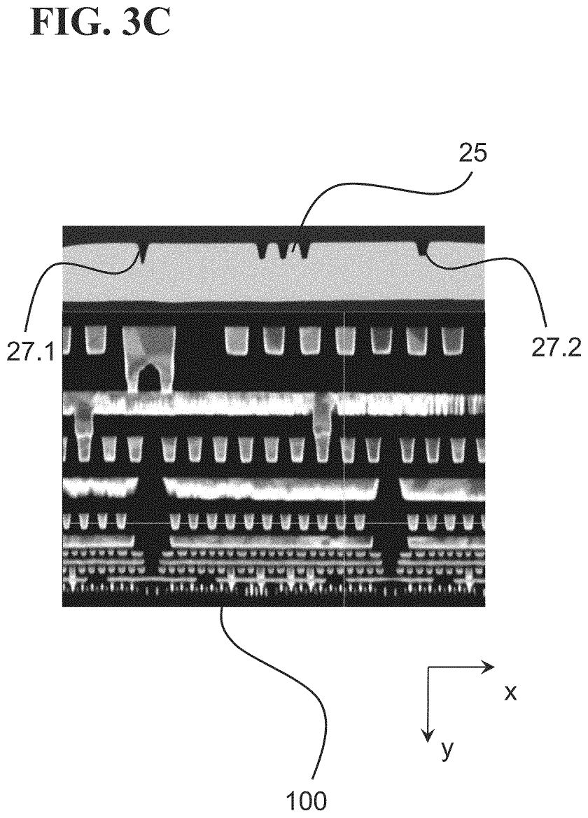

FIGS. 3A-3C illustrate the alignment with fiducials, according to prior art. Illustrated in FIG. 3A, a marker structure or fiducials are formed on top of the sample perpendicular to the direction of the cross sections before the FIB cutting of intersections begins. For the marker structure, first a material 20 is deposed on the top surface 55 of the integrated semiconductor sample. In this material, alignment marks such as parallel lines 21 and inclined lines 22 are formed by FIB processing. FIG. 3B shows an image of a typical alignment structure of the prior art. After slicing and imaging the cross section 11 by raster scanning along raster scanning lines 82, each cross section image 100 contains also a cross section image segment of the fiducials or alignment makers. Illustrated in FIG. 3C is a representative cross section 100. The central markers are visible via their cross section image segments 25 and are used to perform the lateral alignment in x-direction and in y-direction amongst the slices; however, the alignment in y-direction is normally less accurate. The distance between the two cross section image segments 27 of the two outer makers 22 is used to calculate the distance dz between each slice.

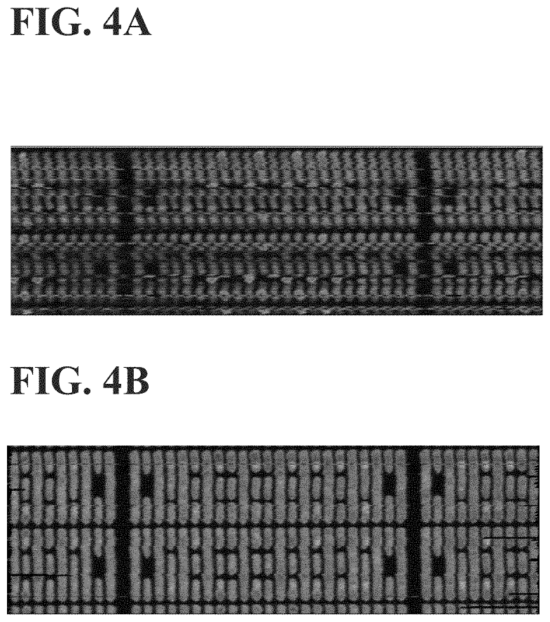

FIGS. 4A and 4B show a result of a reconstruction induced residual line edge roughness for the M1 layer of an integrated semiconductor sample. As in FIG. 2, the images are x-z-intersection images, derived from a sequence of N=400 image slices or cross section images each obtained in x-y-plane. FIG. 4A shows a result of an x-z-intersection image without image slice alignment, and FIG. 4B shows the result with image alignment based on the fiducials. The random stage or SEM drifts between acquisition of the N=400 image slices lead to artificially enhanced line edge roughness in z-direction. The improvement by fiducial alignment is clearly visible by a reduction of image blur and reduction line edge roughness of the gate structures in the gate layer.

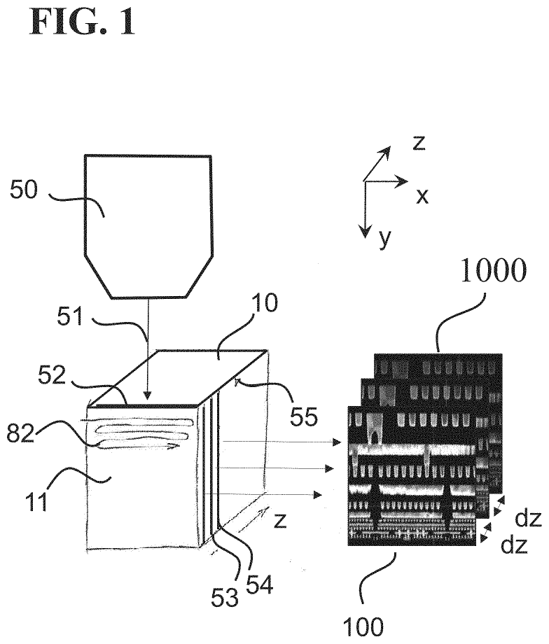

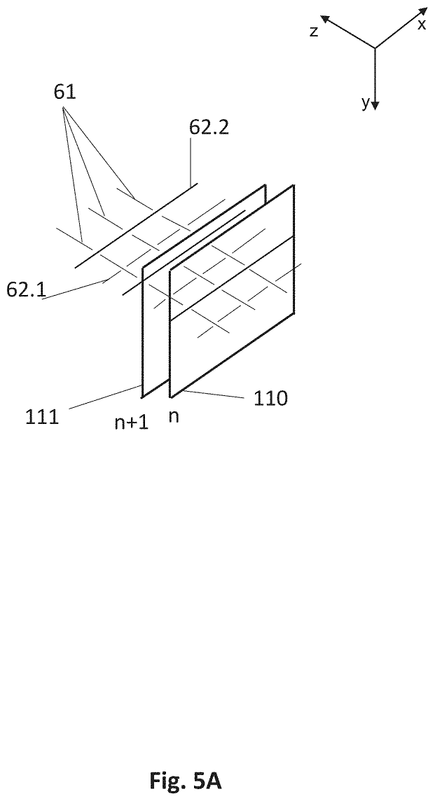

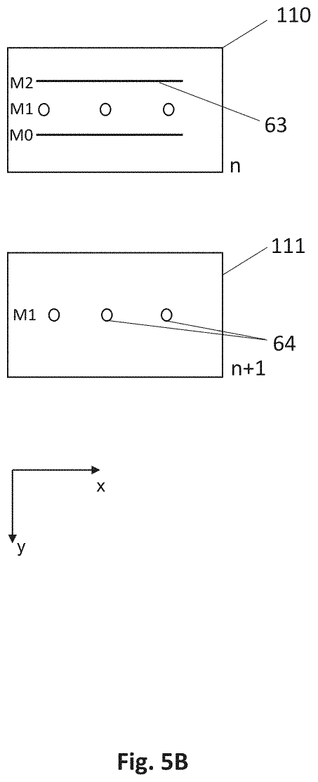

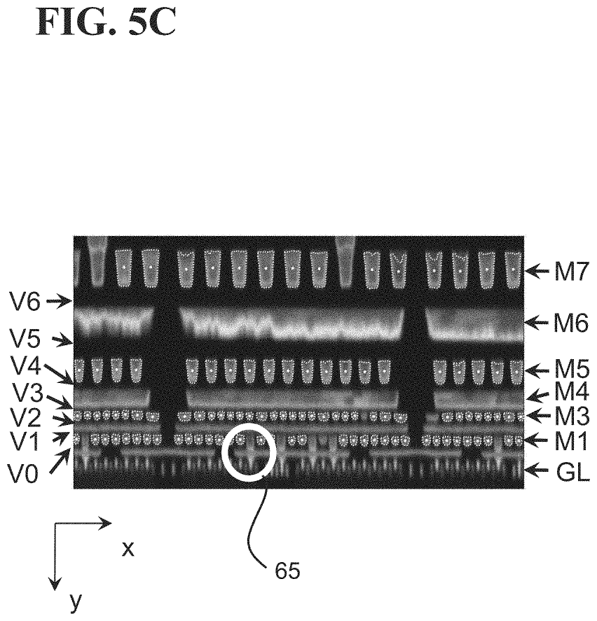

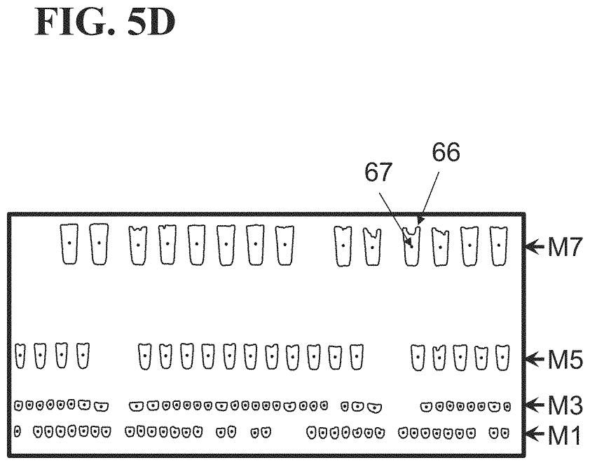

An embodiment of the disclosure for fine alignment based on features or structures in the integrated semiconductor sample is described in of FIGS. 5A-5D. Integrated semiconductor samples as shown in e.g. FIG. 1 consist of (K+1) metal layers (usually referred to as M0, M1, M2 . . . MK counted from the silicon substrate level to the wafer top level) and via layers (usually referred to V0, V1, V2) which are used to connect the metal layers through columnar structures.

FIG. 5A shows a simplified example for two cross section images of an integrated semiconductor sample with metal layers, here for sake of simplicity only three metal layers M0, M1 and M2 are illustrated. The metal layers M0 and M2 include metal lines 62.1 and 62.2 parallel to the N cross section images, from which two are illustrated by n and n+1. The metal layer M1 includes metal lines 61 which are at an angle of 90° to the cross section images n and n+1. The coordinate system is selected to form subsequent first and second cross section images 110 and 111 in x-y direction and perpendicular to the z-direction. The integrated semiconductor probe is thus oriented that at least a number of L metal lines are oriented parallel to the z-direction and thus perpendicular to the cross section image planes parallel to the x-y-plane. Generally, at least a number of L metal lines forms a predetermined angle with a cross section image plane, such that cross section image segments of each of the L metal lines are formed in at least a sequence of the N cross section images. In the embodiment of FIGS. 5A-5C, the predetermined angle is 90°.

FIG. 5B illustrates two of the cross section images with z-index n (110) and n+1 (111). Generally, the cross section images 110, 111 are oriented in the x-y-plane, and the sequence of cross section images or slices are stacked or displaced in z-direction by distance dz between 1 nm-7 nm. Since the cross section cutting or slicing was performed at a predefined angle of 90° to the metal lines 61 in layers M1, it is possible to identify the cross sections image segments 64 of the corresponding metal lines 61 in layer M1 in every slice image and furthermore to extract their positions P(x,y;l), for example by centroid computation or computation of center of gravity C(x,y) of each cross section image segment of each of the l=1 . . . L metal lines. Metal layers M0 and M2 are only visible as cross section image segments 63 in the case where the cross section image 110 intersect the corresponding metal lines 62.1 or 62.2 parallel to the cross section images 110 or 111.

FIG. 5C shows an example for a cross section image of an integrated semiconductor sample with logic structures. Metal layers (M0-M7) alternating with via layers (V0-V6) are indicated. Beneath M0, a gate layer GL are visible. The metal and gate layers include metal lines either parallel or perpendicular to the cross section images. Since the cross section cutting or slicing is performed perpendicular to the metal lines in layers M1, M3, M5, . . . it is possible to identify the cross sections of the corresponding metal lines in that layers in a large set of subsequent cross section images or slices and the centroids of the metal lines can be computed. At least a major part of the metal lines perpendicular to the cross section image, as for example in M1, M3, M5 or M7 are invariant over a large number of subsequent cross section images. The cross section image through the sample shows only a few via, one example is marked with a white circle 65.

The cross section image segments of the perpendicular metal lines in layers M1, M3, . . . , M7 can be extracted by image processing such as corner or edge detection, thresholding, or morphologic operations. Positions of detected metal lines can be computed based on centroid computation or computation of center of gravity. Alternatively, position determination of metal lines can be achieved by for example feature based registration. Generally, pattern recognition and position detection techniques, also called feature registration, can employ comparison of design shapes to the cross section image segments of the metal lines, or of reference cross section image segments of metal lines.

Feature registration can employ image correlation with a reference cross section image segment of for example a metal line, or can be based on the Euclidean image distances between the cross section image and a reference cross section image segment of for example a metal line. Those skilled in the art will be able to use methods equivalent to the above mentioned methods for the position computation of the cross section image segments of metals lines.

In FIG. 5D, the boundary lines of the cross sections of metal lines are indicated by white dotted lines. The positions P(x,y;l) of each metal lines are evaluated (indicated by the dots) as the centroids within each boundary line. FIG. 5D shows as result of the extraction the edge shapes or boundary lines of the metal lines in layers M1, M3, M5 and M7 together with their centroids C(x,y;l) (dots), with one example highlighted (edge shapes or boundary lines 66 of a metal line in layers M7 together with centroid 67).

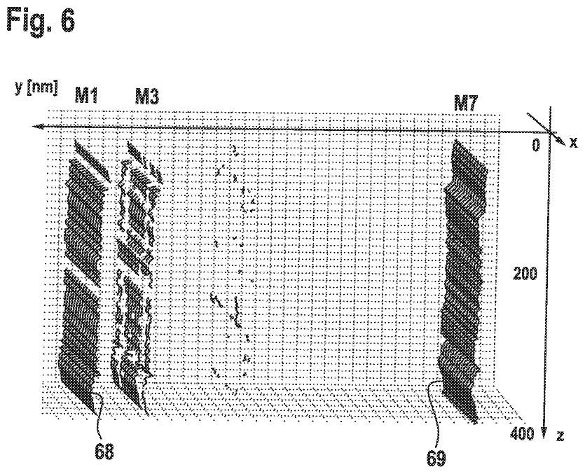

By connecting the centroids of the metal lines from slice to slice the traces of the centroids T(x,y;z;l) through z direction or a sequence of cross section images can be generated. FIG. 6 shows the traces of the centroids of the metal lines in layers M1, M3 and M7 for N=400 cross sections images (z-direction). Two examples 68 and 69 of several traces T(x,y;z;l) for metal layers M1 and M7 are highlighted, respectively. The metal lines are expected to be very straight since they are manufactured with high precision. The traces show some common wavy structure T_x(z) and T_y(z) which stems from the misalignments that shall be corrected. After correcting the misalignments by subtracting off T_x(z) and Ty(z) there will be still a residual wavy structure for each of the traces which stems from the common or average wavy structure TA(x,y;z). This has a random contribution from, e.g. statistical errors in the centroid determination and a systematic contribution, e.g. from changes of the SEM image distortion from slice to slice. The large common or average wavy structure TA(x,y;z) represents the measurement error, induced by stage drift or imaging aberrations and included a common displacement vector and rotation angle error for each z-position in the 3D dataset of the sequence of N=400 cross section images. For sake of simplicity, here only the displacement error is illustrated, and the rotation error can be considered by for example rotation matrices. By extracting the common wavy component TA(x,y;z) of the traces, for example by statistical evaluation over at least a subset the L traces T(x,y;z;l), a major part of x-y misalignment for each cross section image slice at position z can be corrected in a fine alignment correction and slice registration within the 3d volume image dataset.

The extraction of the common wavy component TA(x,y;z) reveals an x-y-displacement vector (x,y) for each cross section images slice at position z, which is based on statistical evaluation of the lateral cross section image displacement. The statistical evaluation improves the accuracy and reduces errors of few individual structures or alignment marks such as the fiducials. Statistical evaluation includes for example averaging, centroid computation and can consider outliers. Examples are averaging of line edges by averaging multiple line edge points, the centroid computation, feature based registration or the statistical averaging over a set of multiple centroid points. Image processing algorithms and registration algorithms can be applied in order to remove artefacts or outliers by comparison of the feature or structure sets between two consecutive cross section images.

It should be mentioned, that the metal lines do not need to extend through the whole measured volume. As illustrated in FIG. 6, not all metal lines extend through all N cross section images. Gaps in metal lines such as in the M1 traces 68 can be identified and bridged by for example M7 traces 69. Generally, gaps can be bridged by other metal lines such that an alignment of the whole measured volume becomes possible. Only in the rare cases where all metal lines end at the same position, the reconstruction is not able to register the part before and after the gap properly. However, in these cases, a registration is not necessary. Since one method of the disclosure relies on structures present in the integrated semiconductor sample to be extracted from the cross section images or the raw 3D stacks, the method of the disclosure is referred to as “structure-based” alignment in contrast to the “fiducial-based” alignment of the prior art. The precision alignment of 2D cross section images slices in a 3D volume image is also referred to as registration or image registration.

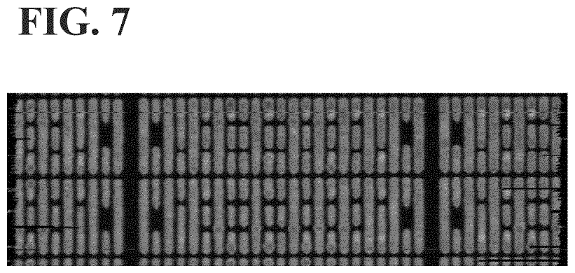

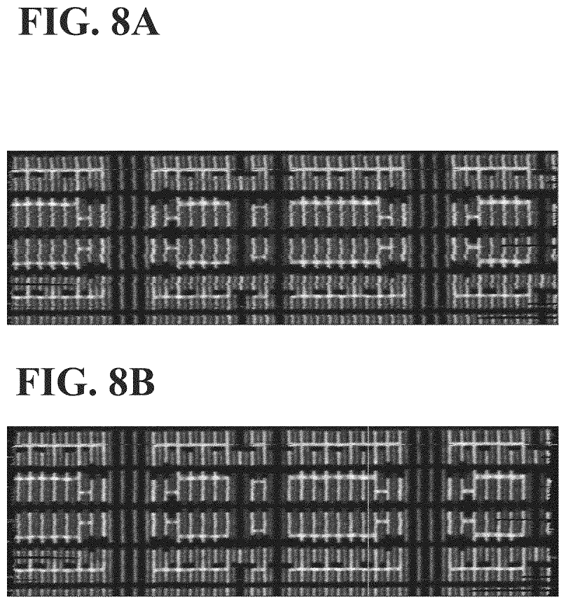

Comparisons between fiducial based alignment and structure-based alignment are shown in FIG. 2 and FIGS. 8A and 8B. FIG. 7 shows the same cross section in x-z direction through the M1 layer as illustrated in FIGS. 4A and 4B, but shows the cross section after the structure-based alignment. FIG. 8A shows a cross section in x-z direction through the gate layer, reconstructed from N=400 cross section images, each obtained in x-y direction, after alignment based on fiducials. FIG. 8B shows the same cross section through the gate layer after the structure-based alignment. The improvement in reduced line edge roughness induced by misalignment or coarse alignment by fiducial-based alignment alone is clearly visible in both images of FIGS. 7 and 8B and becomes more visible at lower layers with finer structures, such as the gate layer.

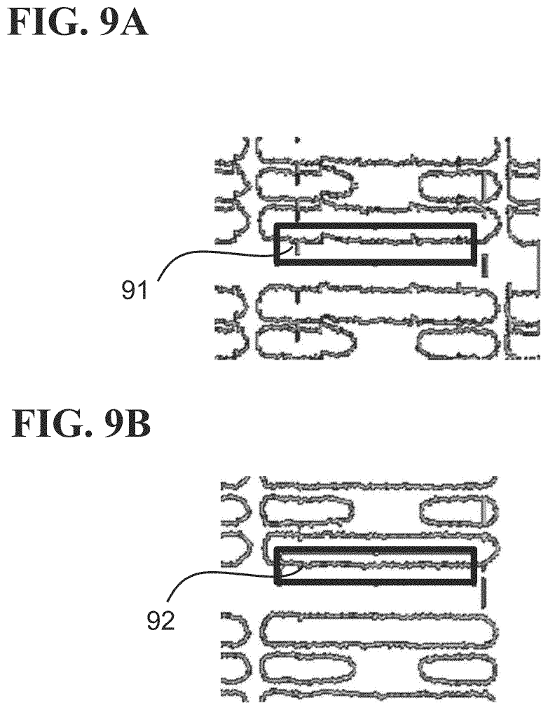

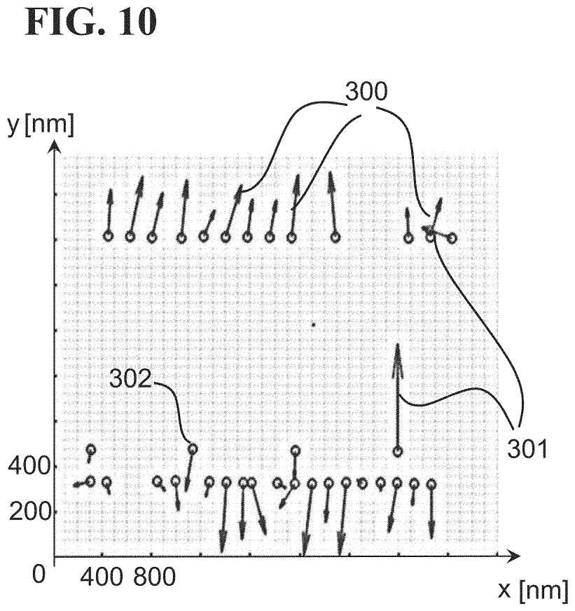

A quantitative comparison of the improvement can be achieved through extracting a contour and calculating the standard deviation of the contour from its mean value. From the examples in FIGS. 9A and 9B, a measure for line edge roughness is extracted from two images. FIG. 9A shows the example of a line segment 91 for fiducial-based alignment, FIG. 9B shows the example of a line-segment 92 as a result for structure-based alignment. In the example for the fiducial based alignment, the standard deviation of the line edge 91 is 24.26 nm, while in FIG. 9B, with the structure-based alignment, the standard deviation of the line edge 92 is reduced by a factor two to 12.8 nm. Generally, the standard deviation can be reduced by structure-based alignment by a factor 1.5-3. The residual measured line edge roughness is thus reduced from artificial misplacements from residual aberrations or alignment errors from the measurement of the fiducials. In an equivalent way, surface roughness values are reduced from artificial misplacements, and the precision of size or dimension measurements for example of a metal line width or gate dimensions can be improved by a factor 1.5-3 with feature-based alignment. Another embodiment is illustrated in FIG. 10. After the correction of the x-y alignment with image registration based on structure- or feature based alignment there may be still some residual drifts of the traces from slice to slice. These drifts may be attributed to a drifting SEM image distortion. Using the residual displacement vectors 300 of the centroids, for which one example is illustrated as 302, image distortion may be determined by for example approximation or fitting with some reasonable basis functions of image distortion, such as low order pin-cushion, toroidal distortion, shear or keystone distortion. These basis functions can be described by x-y-vector polynomials. With the extracted basis functions for distortion, each cross section image can be corrected by subtraction of image distortions to obtain a slice to slice or absolute relative image distortion correction. The distortion correction can be obtained on a slice to slice basis or can involve more than two or all image slices to derive an average distortion and a residual distortion deviation for each individual image slice. FIG. 10 illustrates an example for the extraction of a distortion field, including distortion vectors 300 around the centroids, of which one is labelled by 302. The cross section centroid determination might produce some outliers. Two examples are indicated by number 301. Outliers can be removed e.g. by image comparison or by statistical analysis, or will be suppressed by polynomial fitting of low order distortion polynomials. The systematic distortion change from slice n=80 to slice n=81 in y-direction can be fitted to the reasonable distortion basis functions and applied for correcting the relative distortions from slice to slice. In this example, the low distortion is dominated by a symmetrical barrel distortion in y-direction with an image field dependency proportional to y, and constant in x-direction. The maximum relative change of distortion between slice n=80 and slice n=81 is about 19 nm. Generally, the typical relative distortion change from image to image can be 0-30 nm. The distortion correction can be performed before the feature-based alignment, after the feature-based alignment or can be an integral part of the feature-based alignment with the alignment displacement vectors TA(x,y;z) or rotation vectors as distortion vectors of lowest order for each cross section image at position z.

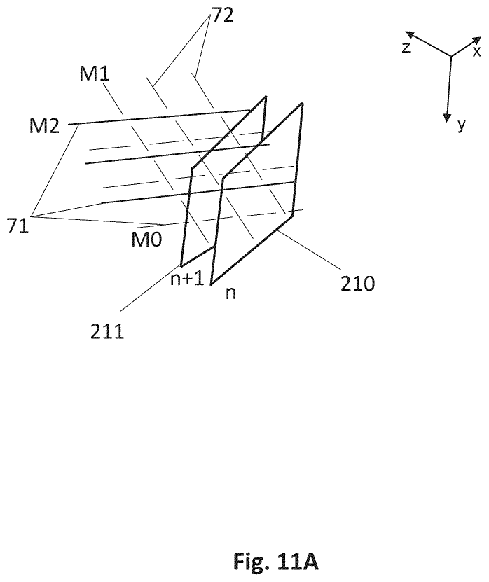

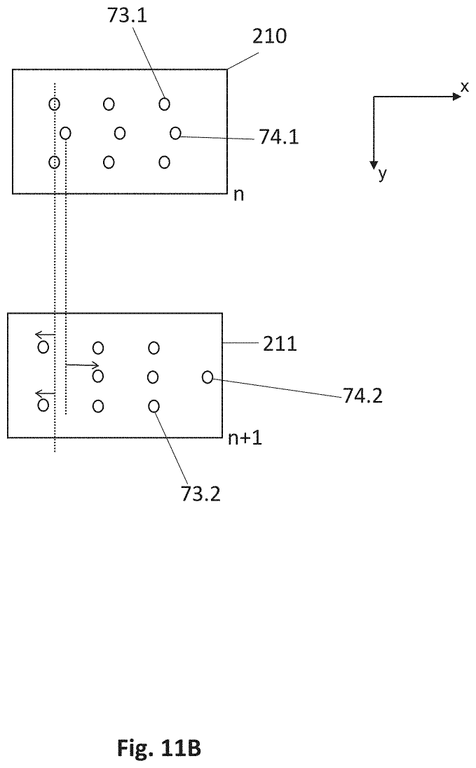

Another embodiment method is illustrated at FIG. 11A. In this embodiment, the integrated semiconductor samples are cut under a predefined angle. The predefined angle describes the angle between for example the metal lines 71 in layer M0 and the cross section x-y-plane. The predefined angle can for example be 45°, but also other angles such as 30° or 60° are possible. The cross section images 210 and 211 through the metal lines 71 in layers M0-M2 are thus at an predefined angle to the metal lines or interconnects, and the position of each metal line in the metal layer M0-M2 change for each slice 210, 211 in a controlled and equal manner, depending on the slicing distance dz and the predetermined angle of the metal lines in that layer of the integrated semiconductor sample. The metal lines 72 are elongated perpendicular to the metal lines 71 and form such a second angle of 90° minus the predetermined angle with the cross section image plane, in this example with predetermined angle of 45° the second angle is also 45° (=90°−45°). The M0 and M2 metal lines 71 “move” block wise to the left from slice 210 to slice 211, while the metal lines 72 of layer M1 “move” block wise to the right. Extracting the traces of the positions for the metal lines according to any methods described above leads to bunches of traces running from right to left (metal lines in layer M0 and M2 in cross sections 210, 211) and traces running from left to right (metal lines in layer M1 in 210, 211). This is illustrated at two examples of cross section images 210 and 211 in FIG. 11B. From the relative distance change of cross section image segments 73.1 and 73.2 of metal lines 71 in layer M0 or M2 and of cross section image segments 74.1 and 74.2 of metal lines 72 in layer M1, which change their position in opposite direction, the slice thickness dz can be derived with high precision. As described above, due to the statistical evaluation utilizing for example a large number of metal traces and the high precision of the fabrication of metal lines, the z-position determination is obtained with higher precision as for fiducial based alignment. From the traces of the positions of the metal lines, detected as described above, the linear displacement of the metal lines according to the predetermined angle and second angle can be extracted and a residual common wave signature of the traces can be extracted. This common wave signature is used for feature based alignment as described above. Using the method of cross section imaging under a predefined angle to the metal lines therefore enables the structure-based alignment in x, y, and z-direction with superior precision to pure fiducial based alignment. In addition, in the case of cross section imaging at an angle to the metal lines, the regular and predetermined positional change of the metal lines in each cross section image can be separated and isolated from distortions as described above, and registration of 2D cross section images in the 3D volume image can be obtained with high accuracy.

In the above embodiments, the cross section image planes are oriented perpendicular to the top surface 55 of the integrated semiconductor wafer, with the normal to the wafer top surface 55 oriented parallel to the y-direction, as shown in FIG. 1. This results in 2D cross section images which are oriented parallel to the y-direction, or, in other words, the cross section image planes include the y-axis or wafer normal axis, and the slicing direction z is perpendicular to the y-axis or wafer normal axis. In another embodiment of the disclosure, the intersection angle of the cross section image planes is inclined to the wafer normal at a predefined inclination angle, and the slicing direction z is not perpendicular, but inclined at a predefined inclination angle to the y-axis or wafer normal axis. In an example, illustrated in FIG. 12A, pillar like HAR structures, e.g. channels or channel holes, with one example referred to by number 75, extending through a significant part of the sample, e.g. a memory chip, become visible in the cross section images. As in the example above, the HAR channels are oriented in a direction at a predefined angle to the cross section image planes, such that cross section images of the HAR channels become visible in the cross section images. Positions of the HAR channels can be detected by the image processing methods described above, for example from their centroids. Low order distortion from imaging can be analyzed and subtracted as described above and image displacement from slice to slice can be computed with high accuracy, thereby obtaining a registration of each 2D cross section image slice in the 3D volume image with high precision. FIG. 12B shows two examples of two 2D consecutive cross sections images with indices n and n+1, with cross section image segments of HAR channels indicated by 77.1 and 77.2. The top boundary surface of the integrated semiconductor structure (see reference number 55 in FIG. 12A) is indicated by reference number 76.

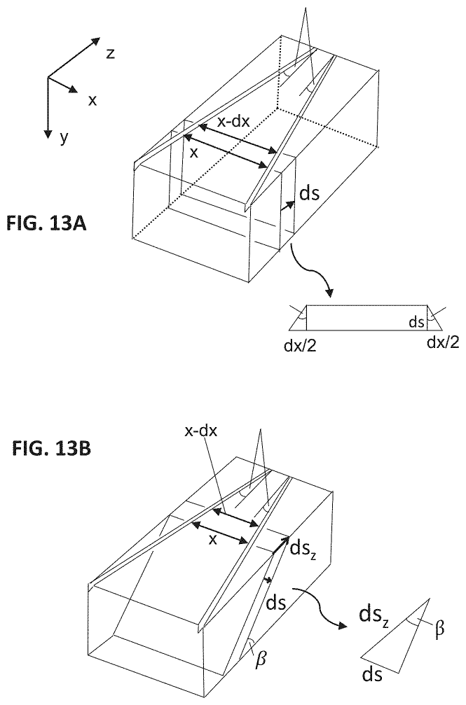

FIGS. 13A and 13B is an illustration comparing accuracy of a distance determination between subsequent cross section images perpendicular to the top surface of an integrated semiconductor sample on the one hand (FIG. 13A) and subsequent cross section images inclined to the foresaid orientation (FIG. 13B). The geometric arrangement according to FIG. 13A is as follows: Cross section images are provided in the x-y-plane, having a distance of ds in z-direction to each other. Furthermore, fiducials 22 are provided on the top surface of the integrated semiconductor sample within the x-z-plane. The fiducials 22 are not parallel, but inclined to one another with an angle of 2α and have a distance in x-direction of values x and x-dx, respectively, at the position of subsequent cross section images. An excerpt of FIG. 13A shows these geometric conditions in more detail. According to trigonometric functions, the distance ds between subsequent cross section images is as follows:

$$d s = \frac{d x}{tan α}$$

The distance dx is measured and the angle α is in principle known, so ds can be calculated. This is in principle known.

Now, referring to FIG. 13B, according to the present disclosure, the cross section images are inclined to the top surface by an angle β describing a glancing incidence of the focused ion beam onto the top surface of the sample. Still, a distance of the fiducials in z-direction ds_{z} at their positions at the top surface is given by

$$dsz = \frac{d x}{tan α}$$

On the other hand, the distance ds now inclined to z-direction is

ds=dsz sin β

which leads to

$$d s = sin β \frac{d x}{tan α}$$

In FIG. 13B, the distance dx can be measured once again with the same accuracy as in FIG. 13A. However, any error included in dx itself or in measuring dx is now reduced by the factor sin β. The same holds for any determination/precision with which the angle α is measured or provided. Therefore, by inclining the cross section images as in FIG. 13B, the overall accuracy in determining the distance between subsequent cross section images can be improved. The same holds if vertical structures, for example HAR channels, included in the integrated semiconductor sample are used for position determination. Here, an important aspect is that any position determination that applies position information from a plane inclined to the principal axis of the sample is more accurate than position determination applying position information from a plane parallel to the principal axis of the sample.

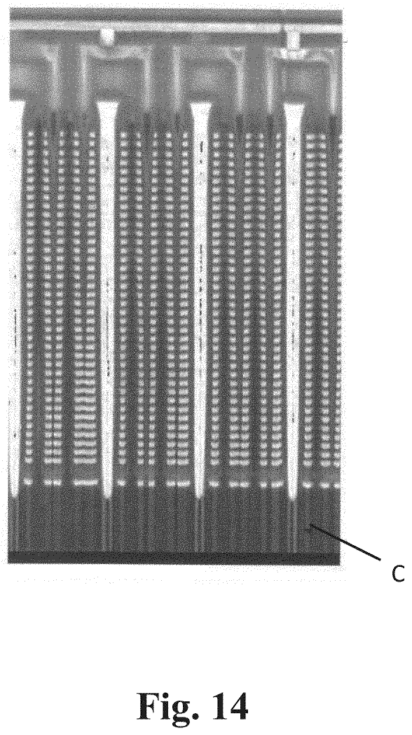

FIG. 14 is an illustration of the curtaining effect imaging a VNAND structure. Lines C are visible in the cross section image which are artefacts due to curtaining. Curtaining occurs due different materials present. Curtaining is very pronounced if repetitive structures are imaged which is the case with the very fine VNAND structures. Depending on the imaging method, the strength of curtaining varies. If secondary electrons are detected as the imaging signal, the curtaining effect is stronger than compared to a set up in which back scattered electrons are detected as a signal. This is due to the fact that secondary electrons are more sensitive to a surface topography and image the topography contrast.

However, also when back scattered electrons are detected as a signal for imaging, curtaining is still a problem, since the image information still stems from different depth on the surface. By a standard image reconstruction, it is assumed that the cross section image obtained by a back scattered electron signal is flat. However, this is not exactly the case. This contradiction leads to errors in image reconstruction and limits the resolution of the 3D image in the virtual, say mathematically reconstructed, image plane.

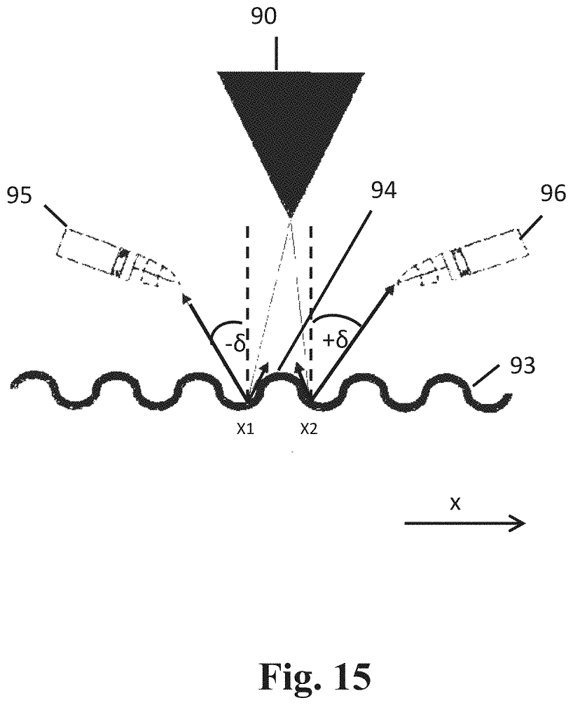

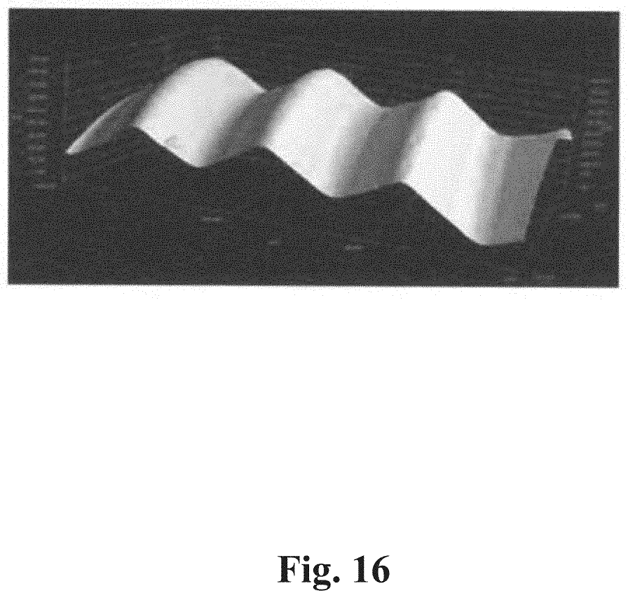

Therefore, according to the present disclosure, the resolution of the 3D image in the virtual image plane is improved by carrying out a curtaining correction. In more detail, the curtaining signature of a new cross section is determined. FIG. 15 schematically illustrates a respective arrangement for determining the 3D topography of a surface. The imaging device 90 can be a charged particle device, for example working with electrons. In the shown example, the imaging device 90 is a SEM. The SEM 90 images the surface 93 of the new cross section resulting from delayering an integrated semiconductor sample with a focused ion beam. The surface 93 is not flat, but wavy with maxima and minima. The scanning direction of the SEM 90 is the x direction in the shown example. Two detection units 95, 96 forming a detection unit pair are provided detecting back scattered electrons as signals. However, it is also possible that secondary electrons emitted from the surface 93 are imaged alternatively or additionally. The geometric arrangement of the detection units 95, 96 is such that they detect signals/particles emanating from the surface 93 under different angles. However, in the embodiment shown, the arrangement of the two detection units 95, 96 is symmetric with respect to the point or area currently imaged: The angles to a normal of the surface 93 (here identical to the direction of the electron beam axis) are +/−δ and the detection units 95, 96 are provided on the same line x, in other words in scanning direction x. However, other angles and positions are also possible.

When imaging a maximum 94 with the SEM 90, the signal strength that the detection units 95 and 96 receive in the form of particles emanating from the same position is slightly different because of a shadowing effect due to the topography. For example, when particles emanating from position x1, the detection unit 95 receives a slightly stronger signal than the detection unit 92. Similarly, when particles emanating from position x2 are detected, the detection signal of detection unit 96 is slightly stronger than the detection signal at detection unit 95. This difference in signal strength can be analyzed easily in the differential signal of both detection units 95, 96. Therefore, it is possible to determine the 3D topography of the surface 93 by scanning the surface 93 for example line by line. The curtaining signature of the surface 93 can therefore be determined and used in reconstruction of the cross section images. The resulting cross section images are themselves 3D images. An example is depicted in FIG. 16. The cross section image of FIG. 16 has a wavy 3D structure. The quantitative 3D information can be used in overall 3D image reconstruction of a 3D volume image with increased accuracy. Alternatively or additionally, the quantitative 3D information can be used in a feedback loop for controlling a focused ion beam while removing the next cross section surface layer of the integrated semiconductor sample.

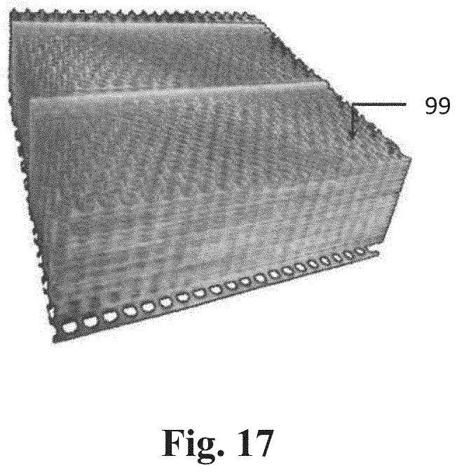

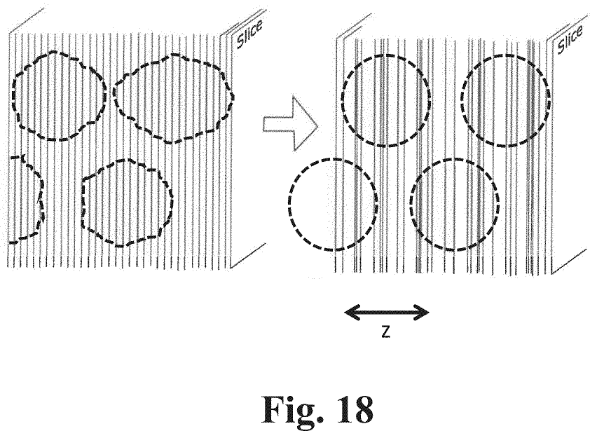

FIG. 17 is an illustration of pillar like structures on a regular hexagonal grid in a VNAND memory probe. The VNAND memory sample is composed of many pillar-like structures running parallel to each other. In the present embodiment, the sample is cut into slices parallel to the “pillars” as shown in FIG. 18. The image plane of the figure is perpendicular to the slices and contains the pillar footprints shown as framed regions. The actual shape of the footprints is expected to be close to a circle. The centroids of the footprints are expected to form a regular (e.g., a hexagonal) grid. Inaccuracy in the determination of the slice positions along the direction perpendicular to the slices and/or deviations of the slice thicknesses from the nominal value lead to a drift of the image scale along this direction. As a result, the pillar cross-sections appear distorted (see the left part of the figure) and their centroid do not form a regular grid any more.

According to the present embodiment, it is proposed to adjust the individual slice position/thickness such that the aforementioned distortion is minimized allowing one to investigate the actual geometrical properties of the individual pillars. The idea of the method is to use the information about the actual shape and the spatial layout of the pillar footprints available, e.g., from the design data or from other considerations (like symmetry). For example, it can be sufficient to assume that the actual pillar cross-sections are on average perfect circles whose centroids form a regular hexagonal grid as described above—a very common design of a VNAND chip. Then the position/thickness of the individual slices are adjusted until the pillar footprints match the assumed geometry (circles on a regular grid) as shown in the right part of FIG. 18. Any other more complex pillar footprint shape and/or spatial distribution of footprint centroids can be assumed. Furthermore, the described concept can be also applied to other structures than VNAND structures and the cross sectional shape of the structures is not necessarily round or elliptical.

Since the actual probe may deviate from design or an assumption about a feature shape may not be accurate enough, the reconstructed pillar cross-sections obtained after the slice position adjustment may still deviate from the actual ones. However, in most cases, one expects the deviations of the pillars from design to be rather local (defects!). For example, a certain pillar might have a shape or a radius deviating from those of its neighbors. Also, its centroid might be offset from a respective position on the regular grid formed by other centroids. Such local deviations or defects will remain after the described adjustment of the slice positions and can thus be investigated. Indeed, the adjusted position of each slice is affected by all the pillar cross-sections “touched” by the slice. The effect of a single pillar cross-section on the adjusted slice position is expected to be relatively small. That is, the proposed adjustment allows to search for local defects while significantly reducing image distortion due to inaccurate slice position determination.

In general, data from any chip containing features with known footprint shapes and spatial distribution in a cross-section (or multiple cross-sections) perpendicular to the actual slices can be processed with the proposed method. The VNAND-memory chip layout is only used as an example with a relatively simple feature footprint.

The described method is also extensible to a case where the slices/cross section images suffer from small lateral offsets. That is, the slices may also be adjusted in a direction parallel to the slice plane (cross section image plane) such that a lateral alignment can be further improved.

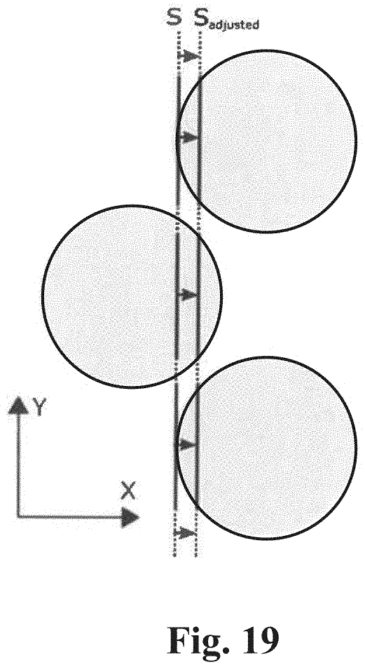

FIG. 19 schematically further illustrates details of the footprint shape based alignment of FIG. 18. Position adjustment of an individual slice S along X-direction is based on a reference image containing the pillar cross-sections of the expected shape and on expected spatial grid (it is noted that the X-direction in FIG. 19 is not identical to the X-direction in other figures (z-direction), but the slightly different terminology has been chosen for ease of understanding of the following).

A specific example of a workflow for the proposed adjustment of the slice positions is as follows: The available information about the actual shape of the pillar footprints (e.g., circles) and their spatial distribution (e.g. a certain regular grid) is used to construct a “reference image” R in the plane perpendicular to the pillars (and to the actual slices) which one expects in the absence of any distortions. An example of such a reference image is shown in FIG. 19. A cross-section of an individual slice in this image is a 1D-line along Y-direction which is denoted with S. The slice S is adjusted along X-direction to match the reference image R consisting of the perfect circles shown in gray located on a perfect grid. Both the reference image and all individual slices are binarized such that all pixels belonging to the pillar footprints are set to one while all other pixels—to zero. The pixel size in the reference image R is set to be equal to the pixel size in the individual slice S. Introducing pixel indices i and k along X- and Y-directions respectively, the reference image can thus be represented as a 2D-matrix R_{(i,k)}=R(xᵢ,yₖ). The individual slice cross-section S can be represented as a 1D-vector Sₖ=S(yₖ). The goal of the method is to find xᵢ, at which the Slice S matches the reference image R at best (see FIG. 19). To do so, a certain range of possible X-positions for the slice S around its nominal position can be tested. For each xᵢ from this range, the value of a merit-function M(xᵢ) is calculated, characterizing how good the slice S matches the reference image R at the position xᵢ:

$$M ( {x}_{i} ) = {M}_{i} = {\sum }_{k} {( {S}_{k} - {R}_{i , k} )}^{2} \qquad$$

Other merit functions can be alternatively defined.

If the range of the tested X-positions is not too large (i.e., the uncertainty of the initial slice position determination is not too high), M will reach a unique minimum at a certain position x_{adjusted}) which can be used as the final position for the individual slice S. The described procedure can be repeated for each individual slice S to obtain the final aligned (adjusted) 3D stack.

The superior precision alignment of the embodiments becomes evident when considering several advantages of the embodiments of the disclosure. First, the metal lines, gates, vias and HAR channels are running each in known planes and under known angles at 90° to each other, respectively, and are manufactured with much more elaborated fabrication technologies than any fiducial marks can be fabricated. Semiconductor fabrication technologies, such as immersion lithography exposure, metal deposition or ion implantation, directed RIE etching, and polishing for integrated circuits are tailored to critical dimensions of few nm, for example 7 nm, 5 nm or 3 nm in near future, and result in a typical pattern placement or overlay accuracy below 2 nm or even below 1 nm precision for the lowest and finest layers such as gate layers and lower metal layers such as M0. Generally, the overlay accuracy of metal lines is about a factor ⅓ better than the shortest dimension of the metal lines, and as a consequence, the low metal layer and gate layer overlay accuracy is in the order of or below 1 nm. The position accuracy or placement and dimensions of the gates or metal lines is thus much better than the typical fiducials produced by the coarse FIB assisted deposition process, with FIB beam diameter in the order of for example 20 nm and FIB scanning positioning accuracy of above 3-5 nm. The metal lines of recent integrated semiconductor samples with minimum feature sizes (CD) of few nm, such as 5 or 3 nm, allow thus a feature based alignment which is at least a factor 3 improved over a fiducial based alignment of the prior art. As a result, the position computation, such as the centroid computation for metal lines or gates leads to a much higher precision and the displacement of the cross section images can be determined much more precise compared to the position of fiducials. The extraction of the metal lines with image processing techniques, optional in combination with the evaluation and subtraction of image distortions, lead such to an improved precision alignment of cross section images via feature or structure based registration.

Second, from the cross section images the position of a metal line, a via, a HAR channel or a gate is derived for example from a contour line. The computation for example of the centroid of a single common feature in two subsequent slices includes statistical averaging and is thus more robust to e.g. image noise and thereby improves accuracy of the alignment of the two image slices. Third, the typical larger number L of metal lines, for example two, five, 10 or up to 100, further improves the statistics of the position determination for purposes of image registration and alignment. Line edge roughness derivation can be improved at least by a factor of 1.5, factors of 2-3 can easily be achieved. Since defects are rare they do not affect the overall quality of alignment methods using many structures at once. The statistical evaluation of feature based alignment is demonstrated to thus enable an improvement of at least factor 1.5 over the fiducial based alignment of the prior art.

In addition, defect candidates can be detected as outliers from the statistical evaluation.

In another embodiment, or in addition to the described above, integrated semiconductor structures are a priory known structures. Design information or 3D CAD information can be used to improve the edge extraction of the metal lines and HAR channels, the position extraction as well as image registration. For example, CAD information can be used to identify locations were metal lines end and therefore should not be visible in cross section images any more. Thereby, outliers of the image processing methods can be reduced. In addition, defect candidates can be detected as outliers from the statistical evaluation.

In another embodiment, the structure or feature-based alignment is combined with fiducial based alignment. Integrated semiconductor samples may include highly repetitive features such as gates in the gate layer, which might lead to ambiguities in the image registration. Generally, a coarse registration with fiducials formed on top of the integrated semiconductor sample can reduce the ambiguity and increase the speed of fine image registration by feature or structure-based alignment according to any of the embodiment of the disclosure.

Image processing methods as described above, such as corner or edge detection, thresholding, or morphologic operations, or similar operations, are well known in the art. Image processing is recently improved by the increase of computation speed for example by usage of computer clusters including several 100s of processors. Image processing methods to extract features or structures of integrated semiconductor samples can also involve or be replaced by Machine Learning algorithms.

The above-described embodiments are intended to be examples only. Despite the embodiments are described at the example of semiconductor structures as probes, the method may as well be applied to materials or probes of comparable structures which allow precise image registration. Alterations, modifications, variations and combinations can be effected to the particular embodiments by those of skill in the art without departing from the scope, which is defined by the claims appended hereto.

List of reference signs

| No. | Item |
|---|---|
| 10 | Sample |
| 11 | cross section surface |
| 20 | surface deposition material |
| 21 | first fiducial markers |
| 22 | second fiducial markers |
| 25 | cross section image segments of first fiducial markers |
| 27 | cross section image segments of second fiducial markers |
| 50 | FIB-column |
| 51 | focus ion particle beam |
| 52 | first cross section surface |
| 53 | second cross section surface |
| 54 | third cross section surface |
| 55 | Sample top surface |
| 61 | first metal lines extended in z-direction |
| 62.1, 62.2 | second metal lines, extended in x-direction |
| 63 | cross section of second metal line |
| 64 | cross section of first metal line |
| 65 | cross section of a via |
| 66 | boundary line of a cross section image segment of a metal |
| | line |
| 67 | centroid of a cross section image segment of a metal line |
| 68 | traces of centroids of cross section image segment of metal |
| | lines in layer M1 through z-direction |
| 69 | traces of centroids of cross section image segment of metal |
| | lines in layer M7 through z-direction |
| 71 | first metal lines elongated in a direction forming a |
| | predetermined angle with the z-direction perpendicular to |
| | the cross section images |
| 72 | second metal lines elongated in a direction forming a |
| | second angle with the z-direction perpendicular to the |
| | cross section images |
| 73.1, 73.2 | cross section image segments of first metal lines 71 |
| 74.1, 74.2 | cross section image segments of second metal lines 72 |
| 75 | HAR channels or metal lines perpendicular to the top |
| | surface 55 |
| 77.1, 77.2 | cross section image segments of HAR channels or metal |
| | lines perpendicular to the top surface |
| 91 | Line edge of a metal line after fiducial-based alignment |
| 92 | Line edge of a metal line after feature-based alignment |
| 93 | wavy surface of a cross section |
| 94 | maximum in topography |
| 95 | first detection unit |
| 96 | second detection unit |
| 100, 100.1, | cross section image |
| 100.2, 100.3 | |
| 101 | metal lines extended in z direction |
| 102 | metal lines extended in x direction |
| 110 | first cross section image |
| 111 | second cross section image |
| 210 | first cross section image |
| 211 | second cross section image |
| 300 | Image distortion vectors |
| 301 | outliers of image distortion vectors |
| 302 | centroid of a cross section image segment of a metal line in |
| | a cross section image |
| 1000 | sequence of cross section images |
| ±δ | angle between surface normal and detection unit |

What is claimed is:

1. A method of obtaining a 3D volume image of an integrated semiconductor sample by alignment based on features of an integrated semiconductor sample, characterized by
obtaining a first cross section image and a second cross section image parallel to the first cross section image, wherein obtaining the first and second cross section images comprises subsequently removing a cross section surface layer of the integrated semiconductor sample using a focused ion beam to make a new cross section accessible for imaging, and imaging the new cross section of the integrated semiconductor sample with an imaging device; and
obtaining a feature based alignment of the first and second cross section images by image registration of each of the first and second cross section images, wherein the image registration is performed based on a common feature of the integrated semiconductor sample in the first and second cross section images.

2. The method of claim 1, wherein the one common feature comprises at least one member selected from the group consisting of a metal line, a via, a HAR structure, a HAR channel, and a gate structure.

3. The method of claim 1, comprising performing the image registration based on at least two common features.

4. The method of claim 1, wherein the image registration comprises a statistical evaluation.

5. The method of claim 1, wherein the statistical evaluation comprises at least one member selected from the group consisting of a computation of a centroid, a feature detection, and a statistical averaging.

6. The method of claim 1, further comprising, before obtaining the feature based alignment, measuring and evaluating the position of alignment marks to provide a fiducial based alignment of the first and second cross sections.

7. The method of claim 1, comprising using an instrument to image the new cross section of the integrated semiconductor sample, wherein the instrument comprises a member selected from the group consisting of a charged particle device, an atomic force microscope, and an optical microscope.

8. The method of claim 1, comprising using an electron beam device to image the new cross section of the integrated semiconductor sample, wherein the focused ion beam and the electron beam are at an angle to each other, and a beam axis of the focused ion beam and a beam axis the electron beam intersect each other.

9. The method of claim 1, wherein the first and second cross section images are perpendicular to a top surface of the integrated semiconductor sample.

10. The method of claim 1, wherein the first and second cross section images are perpendicular to metal lines or gates of a metal layer of the integrated semiconductor sample.

11. The method of claim 9, wherein the first and second cross section images are inclined at an angle deviating from 90° to the metal lines or gates of the metal layer of the integrated semiconductor sample.

12. The method of claim 1, wherein the first and second cross section images are inclined to a top surface of the integrated semiconductor sample to reveal cross section images of at least one HAR channel perpendicular to the top surface of the integrated semiconductor sample.

13. The method of claim 1, wherein the first and second cross section images are inclined to a top surface of the integrated semiconductor sample, and the method further comprises determining a distance between the first and second cross section images based on a position of fiducials on the top surface of the integrated semiconductor sample.

14. The method of claim 1, wherein the first and second cross section images are inclined to a top surface of the integrated semiconductor sample, and the method further comprises determining a distance between the first and second cross section images based on a position of features that are perpendicular to the top surface inside the integrated semiconductor sample.

15. The method of claim 1, comprising subtracting an image distortion deviation between the first and second cross section images during image alignment.

16. The method of claim 15, comprising approximating the image distortion deviation by a basis distortion during image distortion subtraction.

17. The method of claim 1, further comprising:
determining a curtaining signature of the new cross section; and
using the curtaining signature to represent the cross section images as 3D cross section images.

18. The method of claim 1, comprising:
determining a curtaining signature of the new cross section; and
using the curtaining signature in a feedback loop to control the focused ion beam while removing the next cross section surface layer of the integrated semiconductor sample.

19. The method of claim 1, further comprising aligning the first and second cross section images based on a predetermined footprint shape of features and/or a predetermined spatial distribution of the features in the cross section images.

20. The method of claim 19, comprising aligning the first and second cross section images in a direction perpendicular to the image planes of the cross section images and/or within the image plane of the cross section images.

21. The method of claim 1, wherein a footprint shape of the features is circular or elliptical.

22. The method of claim 1, further comprising, after registering the image, combining the first and second cross section images to a 3D volume image.

23. One or more machine-readable hardware storage devices comprising instructions that are executable by one or more processing devices to perform operations comprising the method of claim 1.

24. A system, comprising:
one or more processing devices; and
one or more machine-readable hardware storage devices comprising instructions that are executable by the one or more processing devices to perform operations comprising the method of claim 1.

25. The system of claim 1, further comprising:
a focused ion beam device configured to provide a focused ion beam; and
an electron beam device configured to provide an electron beam,
wherein the focused ion beam and the electron beam are at an angle to each other, and a beam axis of the focused ion beam intersects a beam axis of the electron beam.

26. A method of obtaining a 3D volume image of an integrated semiconductor sample, the method comprising:
obtaining a sequence of N cross section images by a process comprising:
subsequently removing a cross section surface layer of the integrated semiconductor sample using a focused ion beam to make a new cross section accessible for imaging; and
imaging the new cross section of the integrated semiconductor sample with a charged particle imaging device,
wherein each of a cross section image planes of the sequence of N cross section images is oriented perpendicular to a z-direction, the integrated semiconductor sample is arranged that the direction parallel to a set of L metal lines of a metal layer of the integrated semiconductor sample forms an angle with a cross section images plane, and a subset of the sequence of N cross section images includes cross section image segments of the L metal lines;
extracting a position of each of the cross section image segments of the l=1 to L metal lines;
forming traces of the positions through the z-direction of at least a subset of the sequence of N cross section images;
decomposing the traces into an average common wavy structure and a residual deviation; and
correcting the position of at least the subset of the sequence of N cross section images within the 3D volume image by displacing the subset of the sequence of N cross section images with the common wavy structure.
